(19) United States
(12) Patent Application Publication
(10) Pub. No.: US 2014/0097292 A1
(43) Pub. Date: Apr. 10, 2014

(54) AIRCRAFT

(71) Applicant: Liebherr-Aerospace Lindenberg GmbH, (US)

(72) Inventors: Bernhard Hauber, Scheidegg (DE); Tanja Muenz, Scheidegg (DE)

(73) Assignee: Liebherr-Aerospace Lindenberg GmbH, Lindenberg/Allgau (DE)

(21) Appl. No.: 13/803,985

(22) Filed: Mar. 14, 2013

(30) Foreign Application Priority Data
Mar. 16, 2012 (DE) 102012005423.8

(51) Int. Cl. B64C 13/36; B64C 13/26

(52) U.S. Cl. CPC B64C 13/36; B64C 13/26
USPC 244/99.2

(57) ABSTRACT

The present invention relates to an aircraft having at least one landing flap arranged at the wing of the aircraft and having at least one drive unit for actuating the landing flap, wherein the aircraft furthermore has at least one control unit which controls the aileron function of the aircraft, wherein the control unit is connected to the named drive unit or units for adjusting the landing flap(s) and is configured such that it carries out the aileron function of the aircraft in at least one flight mode only or also by the operation of the named drive unit(s) and thus by the adjustment of the landing flap(s).

### BACKGROUND THE INVENTION

The present invention relates to an aircraft. having at least one landing plate arranged at the wing of the aircraft and having at least one drive unit for actuating the landing flap, wherein the aircraft furthermore has at least one control unit which controls the aileron function of the aircraft.

It is known from the prior art to completely separate the aileron function and the high lift function, Le, the drive of the landing flaps, from one another, Such a system known from the prior art is shown in FIG. 5. A half-wing of an aircraft is marked by the reference numeral 10 in this function. Different actuators 20 for adjusting the inner landing flap 30 and the outer lancing flap 40 are located in the half-wing. Two ailerons 50, 60, which are each operated by two separate actuators 52, 54 and 62, 64 respectively, are furthermore provided in the region of the outer edge of the wing.

A PCU, i.e. a power control unit, which represents a central drive unit, is marked by the reference numeral 100. It is thus generally known from the prior art to implement the high-lift functions, i.e. in particular the adjustment of the landing flaps, by central drive units and/or also by drive units between the panels or the landing flaps. A further possibility is to arrange individual drives at the landing flaps.

As can further be seen from FIG. 5, the ailerons 50, 60 are actuated by their own actuators 52, 54 and 62, 64 or by their own drive units independently of the high-lift drive units, i.e. independently of the drive units or actuators 20 of the landing flaps 30, 40.

The arrangement in accordance with FIG. 5 is the same for both half-winos, i.e. the structure is symmetrical with the central PCU 100 which supplies both half-wings, FIG. 1 shows a known embodiment having only one aileron 50 per half-wing 10. In this Figure, the active differential gear box which is in drive communication with the PCU 100 is marked by the reference numeral 200.

This means that in the designs known from the prior art the two drives for the landing flaps and for the ailerons are independent of one another and are completely separate from one another.

The structure known from FIGS. 1 and 5 admittedly represents a very reliable system for operating the high-lift systems and the ailerons; however it is comparatively complex and therefore heavy, which is unwanted.

### SUMMARY OF THE INVENTION

it is therefore the underlying object of the present invention to further develop an aircraft of the initially named kind such that it has a smaller aircraft weight than known designs.

This object is achieved by an aircraft having the features herein. Provision is accordingly made that the control unit is connected to the at least one named drive unit for adjusting the landing flap and is configured such that it carries out the aileron function of the aircraft in at least one flight mode only or also by the operation of the named drive unit and thus by the adjustment of one or more landing flaps. Provision is therefore made in accordance with the invention that at least one landing flap takes over the function of an aileron at least in one flight mode, preferably during the cruise flight. If the pilot thus actuates the corresponding functional unit in the cockpit, the landing flap is adjusted by the drive unit to implement the desired aileron function.

The present invention thus relates to the use of at least one drive unit, for example an electrical or hydraulic drive unit, preferably in the aircraft wing, as well as of at least one landing flap for the partial or complete taking over of the aileron function (primary function), in particular during cruise flight.

This brings along the advantage that redundancies can be saved, that ailerons as such can be saved and that, optionally, the drive of the ailerons can be made simpler such as by the omission of one or more aileron actuators.

The saving of redundancies/actuators at the aileron is thus possible by use of already present drive units in the wing for taking over the partial or complete aileron function. At least one aileron can possibly be completely saved in particular in systems with a plurality of ailerons. The case is also conceivable that ailerons are completely dispensed with.

Generally, one or more landing flaps can be used for carrying out the aileron function.

Provision is made in a preferred embodiment of the invention that a plurality of landing flaps are arranged in the aircraft wing and that the named landing flap is the outer landing flap or, in the case of more than two landing flaps, the outermost landing flap, i.e. the one arranged toward the wing tip.

It is thus conceivable that the outer landing flap is used as the aileron or the outermost landing flap is used which is actuated by the drive unit in the wing (high-lift function). It is conceivable that the inner landing flap or all inner landing flaps are stationary on this actuation of the landing flap used as an aileron. The drive unit can, for example, be a hydraulic or electrical drive unit or also the active differential gear box.

It is generally preferred if the drive unit for adjusting the landing flap in question is arranged in the aircraft wing or in the aircraft half-wing.

Provision is made in a further embodiment of the invention that the aircraft has one, two or more than two ailerons which are each designed with at least one drive unit for adjusting the aileron or ailerons or that the aircraft does not have any ailerons.

As already stated above, it is advantageous if the number of ailerons is reduced by the use of the landing flap(s) as ailerons. It is also conceivable to fully dispense with ailerons. In this case, the function of the aileron is then only taken over by the landing flap or by a plurality of landing flaps.

It is pointed out at this point that the aileron function can be taken over by a landing flap of the half-wing or also by a plurality of landing flaps of the half-wing. The term “landing flap” in claim 1 is thus not restricted to a single landing flap, but can rather also include a plurality of landing flaps per half-wing. The functionality in accordance with the invention is naturally not restricted to one half-wing, but preferably relates to both half-wings.

A weight reduction at aircraft level results due to the association of the high-lift function with the aileron function and thus the possible partial or complete saving of redundancies/actuators at ailerons.

Provision is made in a further embodiment of the invention that the aircraft has at least one aileron and that the control unit is configured such that it carries out the aileron function of the aircraft only by the operation of the named drive unit(s) and thus by the actuation of the landing flap(s) in dependence on the flight mode. It is also conceivable that the aileron function is carried out at least in one flight mode by the operation of the named landing flap(s) and by the actuation of one or more present ailerons or also only by the adjustment of the aileron or ailerons.

If an aileron is present, it can thus carry out the aileron function in an assisting or also exclusive manner—depending on the flight situation. It is also conceivable that this function is carried out only or also by the named landing flap(s), which is in particular conceivable during cruise flight.

The present invention furthermore relates to a method of operating an aircraft having at least one landing flap arranged at the wing of the aircraft and haying at least one drive unit for adjusting the landing flap, wherein the aircraft furthermore has at least one control unit which controls the aileron function of the aircraft. Provision is made in accordance with the invention that on the carrying out of the aileron function the control unit controls the at least one named drive unit of the landing flap(s) in at least one flight mode for example in cruise flight mode, so that the aileron function of the aircraft is only or at least. partly carried out by adjustment of the at least one landing flap.

The control unit which thus carries out the aileron function only via the ailerons in known aircraft is now configured in accordance with the invention such that it carries out this function only or at least also via one or more landing flaps, preferably via one landing flap per half-wing.

it is conceivable that the aircraft has a plurality of landing flaps and that the outer landing flap or, in the case of more than two landing flaps, the outermost one of the landing flaps is adjusted for carrying out the aileron function.

It is furthermore conceivable that on the carrying out of the aileron function by means of one or more landing flaps the inner landing flap or in the case of more than two landing flaps, the inner landing flaps are stationary per half-wing, i.e. are not adjusted.

The present invention finally relates to a method of reducing the aircraft weight, wherein the aircraft is provided with at least one landing flap arranged at the wing of the aircraft and with at least one drive unit for actuating the flap and wherein the aircraft furthermore has at least one control unit which controls the aileron function of the aircraft.

Provision is made in accordance with the invention that on the carrying out of the aileron function the control unit controls the named drive unit(s) of the landing flap in at least one flight mode so that the aileron function of the aircraft is carried out only or also by adjustment of the landing flap(s) and that the method of weight reduction comprises the reduction of the number of ailerons and/or the reduction of the number of actuators or drive units per aileron. Provision is thus made in accordance with the invention that the weight reduction is achieved in that ailerons are omitted with respect to known designs and/or in that the number of drive units per aileron is reduced with respect to known designs.

The method in accordance with the invention thus relates to the fact that with a certain aircraft type a weight reduction is achieved by the omission of ailerons and/or by the reduction of the number of actuators or drive units per aileron.

Provision is made in a further embodiment of the invention that with one and the same type or model of aircraft the number of ailerons is reduced, for example, from two ailerons to one aileron or that the number of drive units is reduced from two drives units to one drive unit per aileron. It is equally conceivable that an aileron is wholly omitted so that only landing flaps are available for carrying out the aileron function.

### BRIEF DESCRIPTION OF THE DRAWINGS

The present invention finally relates to the use of a preferably electrical or hydraulic drive unit and to a landing flap for a partial or complete taking over of the aileron function of an aircraft.

Further details and advantages of the invention will be explained in more detail with reference to an embodiment shown in the drawing. There are shown:

FIG. 2: a schematic view of a half-wing with only one aileron per half-wing;

FIG. 3: a schematic view of a half-wino with two ailerons which are each operated by a drive unit;

FIG. 4: a schematic view of a half-wing without an aileron; and

FIGS. 1, 5: schematic views of arrangements of landing flaps and ailerons in a half-wing known from the prior art.

### DESCRIPTION OF THE PREFERRED EMBODIMENTS

The embodiment shown in the following relates to the use of an electrical or hydraulic drive unit in an aircraft wing or in a half-wing as a part of the high-lift system and of the outboard panel for the partial or complete taking over of the aileron function (primary function).

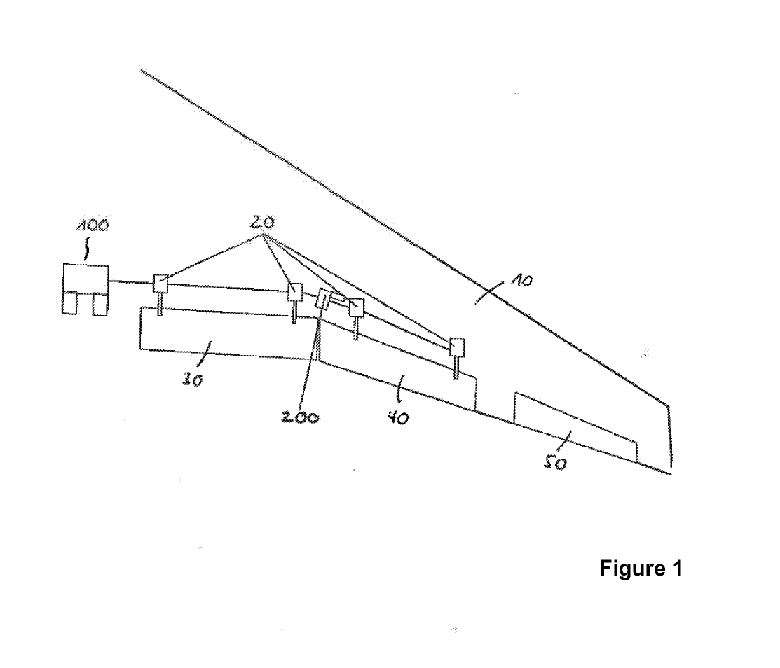

The drive unit can, for example, be the active differential gear box which is marked by the reference numeral 200 in FIG. 2 and which is connected to the actuators 20 which are used for trimming the landing flaps 30, 40. The gear box 200 or the actuators 20 are expanded by the functionality of the actuation as or of the ailerons. This configuration is in particular suitable for long-haul aircraft and aircraft having two ailerons per wing. A use in other aircraft sizes and aircraft configurations is likewise conceivable. The reference numeral 50 designates the only aileron per half-wing 10 which is driven by the actuators 52 and 54.

The half-wing 10 of a long-haul aircraft is shown in FIG. 2 in which an aileron is completely omitted, namely the aileron 60 in accordance with FIG. 5. The aileron function is replaced in at least one operating mode or flight mode by the active differential gear box 200 and the outer one of the landing flaps, i.e. by the landing flap 40.

Aircraft types having two outer ailerons or having an inner and an outwardly disposed aileron are known from the prior art. In both cases, the replacement of an aileron with the use of the outer flap as an aileron is possible.

This brings along the advantage that a supply system is omitted which was originally present in the two ailerons in accordance with FIG. 5 so that a system is omitted which is replaced with the gear box 200. The gear box 200 can generally be designed as hydraulic or also as electrical. In the embodiment shown here, it serves the drive of the landing flaps 30, 40 which are in turn operated via actuators 20 which are connected drive-wise to the gear box 200.

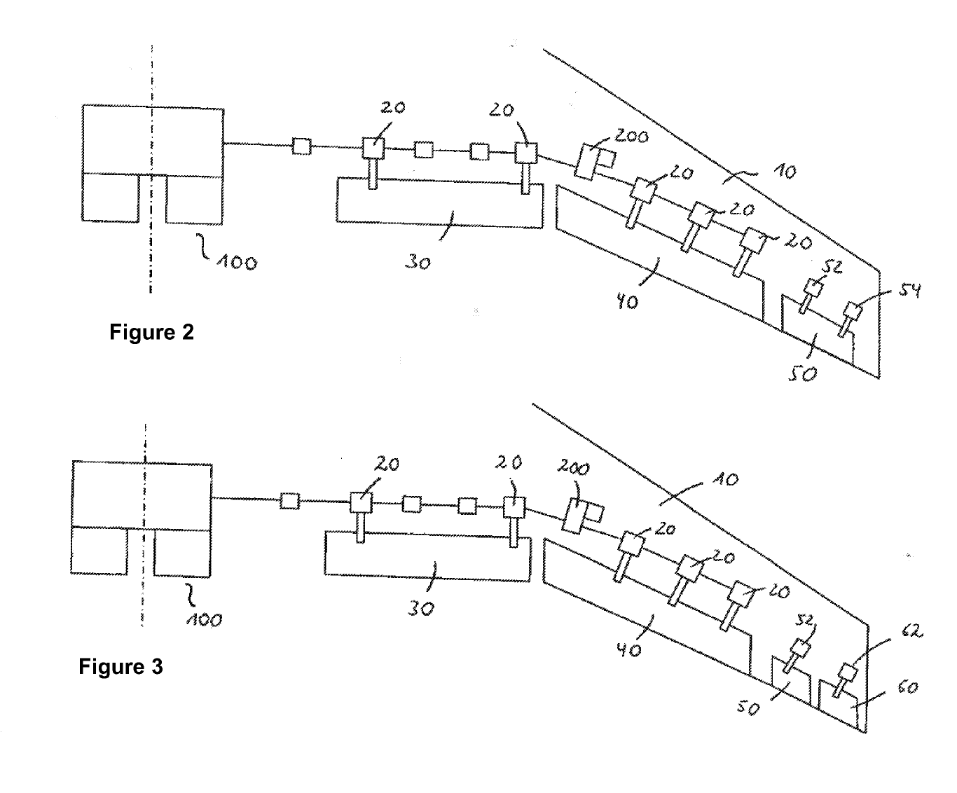

FIG. 3 shows an embodiment in which both ailerons 50, 60 of the half-wing 10 known from the prior art in accordance with FIG. 5 are maintained, but are in each case operated by only one actuator 52, 62. This can be seen in FIG. 3, Respective ailerons are admittedly provided here per half-wing 10 in comparison with the embodiment in accordance with FIG. 5. They are, however, each only operated b, a drive unit or by an actuator. It is thus conceivable and covered by the invention to maintain both ailerons, to operate them in each case only with a smaller number of actuators than from the prior art and to provide the outer landing flap 40 with the gear box 100 as a redundancy to the use as ailerons.

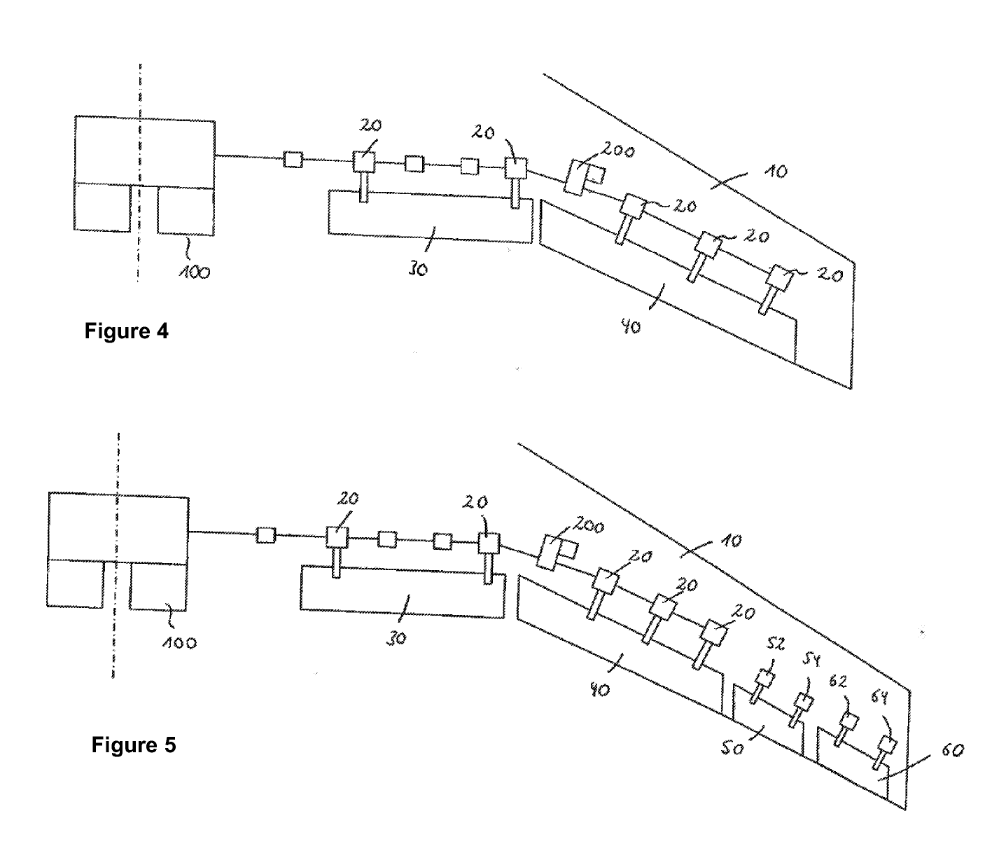

FIG. 4 shows a further embodiment in accordance with the present invention. This embodiment can in particular be considered in short-haul aircraft which originally only have one aileron. It can now be completely omitted in accordance with FIG. 4 and the outer flap 40 serves as sole aileron. This can be changed, if required, in its size with respect to the prior art and can be driven with the aid of the active differential gear box 200. The gear box 200 and the outer landing flap 40 thus completely take over the aileron function.

In the embodiments in accordance with the invention, one or more wing-tip brakes can be provided per half-wing and the adjustment of the individual flaps or rudders or the drive shafts can be braked or blocked by them. They are not shown in the Figures.

An improvement in the weight and cost balance is achieved by the present invention as well as of the safety of the high-lift system of an aircraft. The drive unit can be arranged in the aircraft wing or in the half-wing or also at a central site in the fuselage of the aircraft. Provision is preferably made to use an electrical or hydraulic drive unit in the aircraft wing, namely as a part of the high-lift system as well as the outboard panel, i.e. the outwardly disposed landing flap, and indeed for the partial or complete taking over of the aileron function. This in particular applies during cruise flight, it may be necessary in other flight situations to carry out the aileron function only via the ailerons provided for this purpose or at least assisted by these ailerons.

Where possible, it is conceivable in particular to use the outer landing flap as the aileron which is actuated by the drive unit in the wing (high-lift function). The inwardly offset or inner landing flap can be stationary in this respect.

This configuration allows the saving of redundancies/actuators at the aileron by using already present drive units in the wing for taking over the partial or complete aileron function. As stated, in systems with a plurality of ailerons, one aileron can possibly be completely saved.

A weight reduction results du to the association of the high-lift function with the aileron function and thus the possible partial or complete saving of redundancies/actuators at the aileron.

The arrangements in accordance with the invention shown in FIGS. 2 to 4 are preferably present in both half-wings. The arrangement is preferably mirror symmetrical.

1. An aircraft having at least one landing flap arranged at the wing of the aircraft and having at least one drive unit for actuating the landing flap, wherein the aircraft furthermore has at least one control unit which controls the aileron function of the aircraft, wherein the control unit is connected to the named drive unit or units for adjusting the landing flap(s) and is configured such that it carries out the aileron function of the aircraft in at least one flight mode only or also by the operation of the named drive unit(s) and thus by the adjustment of the landing flap(s).

2. An aircraft in accordance with claim 1, wherein a plurality of landing flaps are arranged in the aircraft wing; and the named landing flap is the outer or outermost landing flap.

3. An aircraft in accordance with claim 1, wherein the drive unit is a hydraulic or electrical drive unit and/or the active differential gear box.

4. An aircraft in accordance with claim 1, wherein the aircraft has one, two or more than two ailerons which are each designed with at least one drive unit for adjusting the aileron or ailerons; or the aircraft does not have any ailerons.

5. An aircraft in accordance with claim 1, wherein the aircraft has at least one aileron; and the control unit is configured such that it carries out the aileron function of the aircraft only by the operation of the named drive unit(s) of the landing flap(s) and thus by the actuation of the landing flap(s), by the operation of the named drive unit(s) and thus by the adjustment of the landing flap(s) and by the actuation of the aileron or ailerons or only by the adjustment of the aileron or ailerons in dependence on the flight mode.

6. A method of operating an aircraft having at least one landing flap arranged at the wing of the aircraft and having at least one drive unit for adjusting the landing flap, wherein the aircraft furthermore has at least one control unit which controls the aileron function of the aircraft, and on carrying out the aileron function, the control unit controls the at least one drive unit of the landing flap(s) in at least one flight mode so that the aileron function of the aircraft is only or also carried out by adjusting the one or more landing flap(s).

7. A method in accordance with claim 6, wherein the aircraft has a plurality of landing flaps; and the outer or the outermost of the landing flaps is adjusted to carry out the aileron function.

8. A method in accordance with claim 6, wherein the aircraft has a plurality of landing flaps; and on the carrying out of the aileron function the inner landing flap or flaps is/are stationary, i.e. is/are not adjusted.

9. A method of reducing the weight of an aircraft having at least one landing flap arranged at the wing of the aircraft and having at least one drive unit for actuating the landing flap, wherein the aircraft furthermore has at least one control unit which controls the aileron function of the aircraft, and on carrying out the aileron function, the control unit controls the at least one drive unit of the landing flap(s) in at least one flight mode so that the aileron function of the aircraft is only or also carried out by adjusting the landing flap(s); and the method comprises the reduction of the number of ailerons and/or the reduction of the number of drive units per aileron.

10. A method in accordance with claim 9, wherein the number of ailerons is reduced from two to one or from one to zero; and/or the number of drive units per aileron is reduced from two to one.

11. Use of at least one landing flap arranged at the wing of an aircraft and of at least one drive unit for actuating the landing flap for carrying out the aileron function of the aircraft in at least one flight mode.

12. An aircraft in accordance with claim 2, wherein the drive unit is a hydraulic or electrical drive unit and/or the active differential gear box.

13. An aircraft in accordance with claim 12, wherein the aircraft has one, two or more than two ailerons which are each designed with at least one drive unit for adjusting the aileron or ailerons; or the aircraft does not have any ailerons.

14. An aircraft in accordance with claim 3, wherein the aircraft has one, two or more than two ailerons which are each designed with at least one drive unit for adjusting the aileron or ailerons; or the aircraft does not have any ailerons.

15. An aircraft in accordance with claim 2, wherein the aircraft has one, two or more than two ailerons which are each designed with at least one drive unit for adjusting the aileron or ailerons; or the aircraft does not have any ailerons.

16. An aircraft in accordance with claim 15, wherein the aircraft has at least one aileron; and the control unit is configured such that it carries out the aileron function of the aircraft only by the operation of the named drive unit(s) of the landing flap(s) and thus by the actuation of the landing flap(s), by the operation of the named drive unit(s) and thus by the adjustment of the landing flap(s) and by the actuation of the aileron or ailerons or only by the adjustment of the aileron or ailerons in dependence on the flight mode.

17. An aircraft in accordance with claim 14, wherein the aircraft has at least one aileron; and the control unit is configured such that it carries out the aileron function of the aircraft only by the operation of the named drive unit(s) of the landing flap(s) and thus by the actuation of the landing flap(s), by the operation of the named drive unit(s) and thus by the adjustment of the landing flap(s) and by the actuation of the aileron or ailerons or only by the adjustment of the aileron or ailerons in dependence on the flight mode.

18. An aircraft in accordance with claim 13, wherein the aircraft has at least one aileron; and the control unit is configured such that it carries out the aileron function of the aircraft only by the operation of the named drive unit(s) of the landing flap(s) and thus by the actuation of the landing flap(s), by the operation of the named drive unit(s) and thus by the adjustment of the landing flap(s) and by the actuation of the aileron or ailerons or only by the adjustment of the aileron or ailerons in dependence on the flight mode.

19. An aircraft in accordance with claim 12, wherein the aircraft has at least one aileron; and the control unit is configured such that it carries out the aileron function of the aircraft only by the operation of the named drive unit(s) of the landing flap(s) and thus by the actuation of the landing flap(s), by the operation of the named drive unit(s) and thus by the adjustment of the landing flap(s) and by the actuation of the aileron or ailerons or only by the adjustment of the aileron or ailerons in dependence on the flight mode.

20. An aircraft in accordance with claim 4, wherein the aircraft has at least one aileron; and the control unit is configured such that it carries out the aileron function of the aircraft only by the operation of the named drive unit(s) of the landing flap(s) and thus by the actuation of the landing flap(s), by the operation of the named drive unit(s) and thus by the adjustment of the landing flap(s) and by the actuation of the aileron or ailerons or only by the adjustment of the aileron or ailerons in dependence on the flight mode.
